(19) United States
(12) Patent Application Publication
(10) Pub. No.: US 2006/0067268 A1
(43) Pub. Date: Mar. 30, 2006

(54) Method for controlling power and a transmission rate of a shared forward link data channel in a mobile communication system

(75) Inventors: Jae-Iiyok Lee, Seoul (KR); Sung-Kwon Jo, Suwon-si (KR); In-Ky Cho, Hwaseong-si (KR); Soung-Il Yoon, Seongnam-si (KR); Dong-Keon Kong, Suwon-si (KR); Dong-Jo Cheong, Yongin-si (KR); Jae-Ho Jeon, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/211,568

(22) Filed: Aug. 26, 2005

(30) Foreign Application Priority Data
Aug. 27, 2004 (KR) 2004-68171

(51) Int. Cl. H04Q 7/00

(52) U.S. Cl. 370/328; 370/252

(57) ABSTRACT

A method for controlling power of a shared forward link data channel for multicasting in a mobile communication system. The method includes the steps of initializing a virtual gain for each mobile terminal with which the shared forward link data channel is established, receiving power control request information from each mobile terminal to adjust the virtual gain of each mobile terminal, selecting a largest virtual gain among the adjusted virtual gains as a control power value of the shared forward link data channel, and regulating the power of the shared forward link data channel to the selected control power value.

### CLAIM OF PRIORITY

This application claims the benefit under 35 U.S.C. §119(a) of an application entitled METHOD FOR CONTROLLING POWER AND TRANSMISSION RATE OF SHARED FORWARD LINK DATA CHANNEL IN MOBILE COMMUNICATION SYSTEM filed in the Korean Intellectual Property Office on Aug. 27, 2004 and assigned Serial No. 2004-68171, the entire contents of which are hereby incorporated by reference.

### BACKGROUND OF THE INVENTION

1. Field of the Invention

The present invention relates generally to power control of a wireless channel providing information from a base transceiver station to a mobile terminal in a mobile communication system. More particularly, the present invention relates to a method for controlling power and a transmission rate of a shared forward link data channel providing information from a base transceiver station to a mobile terminal so as to be able to efficiently use wireless resources for multicast in a Push-To-Talk (PTT) group call service in a Code Division Multiple Access (CDMA) mobile communication system.

2. Description of the Related Art

Mobile communication systems have developed from systems based on voice-only services to systems including voice and data services. The mobile communication systems based on voice and data services are currently evolving into systems for providing faster and improved services.

Requirements for mobile communication systems capable of transmitting data at a high speed include, for example, Evolution Data Only (1× EV-DO) mobile communication systems and Evolution Data and Voice (1× EV-DV) mobile communication systems which are provided in the Third Generation Partnership Project 2 (3GPP2) mobile communication standards.

The 1× EV-DO mobile communication systems are directed only to high-speed data services, and not to voice services. However, methods for providing limited voice services in the 1× EV-DO mobile communication systems are currently under discussion.

Mobile communication services currently under discussion for providing restricted voice call capability in the 1× EV-DO mobile communication systems include, for example, Voice over Internet Protocol (VoIP) voice services and PTT voice services.

PTT mobile communication services will now be described. A mobile communication service such as a voice call service provided in a wireless mobile communication system has evolved from a one-to-one mode into a one-to-many mode. PTT communication is an example of a communication service supporting the one-to-many mode. PTT communication can provide inexpensive multiparty communication for use in the 1× EV-DV mobile communication system for voice and data services or in the 1× EV-DO mobile communication system for data-only services.

PTT communication can be implemented through networks to which a PTT server is added. A group call function of the PTT communication is a one-to-many communication function which allows a single sender to transmit information to multiple receivers at the same time. In order to efficiently use the group call function, multicast is required to allow several users to perform communication using their own mobile terminal through one physical channel.

The 1× EV-DV system defines a Broad Cast and Multi Cast Signaling (BCMCS) channel for performing broadcasting with the mobile terminal. According to specifications of the 1× EV-DV system, frame error-based power control of a frame unit having a period of 20 msec can be performed using an existing Power Control Bit (PCB) or Erasure Indicator Bit (EIB) and Quality Indicator Bit (QIB) for the purpose of power control of the BCMCS channel.

However, the 1× EV-DV standard does not clearly state how to perform power control on a forward link data channel shared by the mobile terminals. The power control of the shared forward link data channel is not fit for rapid power control for meeting the condition that all the receivers must receive the same transmitted data in the one-to-many communication for the PTT service.

In the one-to-many communication based on the shared forward link data channel, power control of the forward link data channel is performed with reference to power control request information that is transmitted to multiple mobile terminals in a reverse direction and then received from the mobile terminals.

FIG. 1 is a flowchart showing one example of a conventional method for controlling power of a forward link data channel in a one-to-one mobile communication system.

First, a base transceiver station (BTS) 10 and a mobile terminal (MT) 20 establish a forward link data channel at step S11. The MT 20 receives signals through the established forward link data channel and determines power control request information required for more stable reception of the signals by referring to the power levels or values of the signals at step S13. The power control request information is focused on whether to increase or decrease the power of the currently established forward link data channel. In other words, the power control request information is information on a request to increase or decrease the power of the forward link data channel. The MT 20 transmits the determined power control request information to the BTS 10 at step S15.

The BTS 10 increases or decreases the power of the forward link data channel established with the MT 20 on the basis of the power control request information received from the MT 20, thereby regulating the power of the forward link data channel at step S17. Thereby, the BTS 10 and MT 20 establish the forward link data channel based on the regulated power at step S19.

In this manner, the forward link data channel is established by regulating the power of the forward link data channel between the BTS 10 and the MT 20 on the basis of the power control request information that the MT 20 requests, so that the MT can receive data in a more stable and accurate manner.

FIG. 2 is a flowchart showing one example of a conventional method for controlling power of a shared forward link data channel for multicast used in a group call service in a one-to-one mobile communication system.

First, a BTS 10 establishes a shared forward link data channel common to MTs 22, 24 and 26 at step S21. The MTs 22, 24 and 26 receive signals through the shared forward link data channel that has been established, and determine power control request information required for optimal reception of the signals by referring to the power of the signals at steps S23, S25 and S26. In other words, the MTs 22, 24 and 26 determine the power control request information indicating whether to increase or decrease the power of the shared forward link data channel. Then, each of the MTs 22, 24 and 26 transmits each piece of determined power control request information to the BTS 10 at steps S31, S33 and S35.

The BTS 10 regulates the power of the shared forward link data channel established with the MTs 22, 24 and 26 on the basis of peak-power control request information among the pieces of power control request information received from the MTs 22, 24 and 26 at step S37. Thereby, the BTS 10 establishes the shared forward link data channel with MTs 22, 24 and 26 based on the regulated power at step S39.

However, when the BTS 10 establishes the shared forward link data channel with the MTs 22, 24 and 26 based on the peak-power control request information, there is a problem in that unwanted power is generated from the other BTSs excluding the BTS to which the MTs 22, 24 and 26 transmit the peak-power control request information. This is because the BTS 10 establishes the one-to-many channel with the MTs based on limited power. Consequently, when the BTS 10 establishes the shared forward link data channel with the MTs 22, 24 and 26 based on the peak-power control request information, there is a problem in reducing the number of MTs with which the BTS 10 can be connected.

Further, the conventional method for controlling the power of the shared forward link data channel has a problem in that, when at least one of the MTs 22, 24 and 26 connected to the BTS 10 in a group requests an increase in the power based on the power control request information, the BTS 10 maintains the power of the shared forward link data channel in the increased state. As a result, the reliability of the power control is deteriorated.

### SUMMARY OF THE INVENTION

The present invention substantially solves the above and other problems and provides a method for controlling power and transmission rate of a shared forward link data channel for group calling of one-to-many communication in a Push-To-Talk (PTT) service of a mobile communication system.

It is another objective of the present invention to provide a method for controlling power and a transmission rate of a shared forward link data channel capable of efficiently performing one-to-many communication such as group calling, employing multicast among PTT services of a mobile communication system between a base transceiver station and mobile terminals.

It is yet another objective of the present invention to provide a method for controlling power and a transmission rate of a shared forward link data channel capable of minimizing power loss and enhancing reliability while a base transceiver station controls the power of the shared forward link data channel for mobile terminals in one-to-many communication employing multicast among PTT services of a mobile communication system.

In order to accomplish these objectives, according to an aspect of the present invention, a method is provided for controlling power of a shared forward link data channel for multicast in a mobile communication system. The method comprises the steps of initializing a virtual gain for each mobile terminal with which the shared forward link data channel is established, receiving power control request information from each mobile terminal to adjust the virtual gain of each mobile terminal, selecting a largest virtual gain among the adjusted virtual gains as a control power value of the shared forward link data channel, and regulating the power of the shared forward link data channel to the selected control power value.

Preferably, the power control request information comprises at least one of a Power Control Bit (PCB), Erasure Indicator Bit (EIB), and Quality Indicator Bit (QIB).

Here, the method may further comprise the steps of comparing the adjusted virtual gain of each mobile terminal with a value obtained by subtracting a set threshold value from real control power of the shared forward link data channel, and when at least one of the adjusted virtual gains is less than the value obtained by subtracting the set threshold value from the real control power of the shared forward link data channel, maintaining the at least one adjusted virtual gain at the value obtained by subtracting the set threshold value from the real control power of the shared forward link data channel.

Further, the method may further comprise the steps of comparing a set threshold value with a value obtained by subtracting a virtual gain of a previous arbitrary period section from the adjusted virtual gain of each mobile terminal, and when the value obtained by subtracting the virtual gain of the previous arbitrary period section from the adjusted virtual gain is greater than the set threshold value, regulating the adjusted virtual gain to the currently set power of the shared forward link data channel.

According to another aspect of the present invention, a method is provided for controlling a transmission rate of a shared forward link data channel for multicast in a mobile communication system. The method comprises the steps of initializing a virtual transmission rate for each mobile terminal with which the shared forward link data channel is established, receiving transmission rate request information from each mobile terminal to adjust the virtual gain of each mobile terminal, selecting a lowest transmission rate among the adjusted virtual transmission rates as a control transmission rate value of the shared forward link data channel, and regulating the transmission rate of the shared forward link data channel to the selected control power value.

Preferably, the transmission rate request information may comprise Data Rate Control (DRC).

According to yet another aspect of the present invention, a method is provided for controlling a transmission rate of a shared forward link data channel for multicast in a mobile communication system. The method comprises the steps of transmitting, at a base transceiver station, data transmission rate information of the shared forward link data channel to mobile terminals with which the shared forward link data channel is established, receiving, at each of the mobile terminals, the data transmission rate information to detect a data transmission rate allocated to itself, and maintaining, at each of the mobile terminals, a state in which reception is possible based on the detected data transmission rate.

Here, the data transmission rate information may be transmitted to each of the mobile terminals in a forward data rate indicator format. Further, the data transmission rate information may be allocated to a predetermined portion of Media Access Control (MAC) and transmitted. In addition, the data transmission rate information may be transmitted to each of the mobile terminals through a downward control channel.

With this configuration according to an aspect of the present invention, the base transceiver station initializes the virtual gain (power) for each of the mobile terminals that are in the group establishing the shared forward link data channel, and then regulates each virtual gain on the basis of the power control request information received from the mobile terminals to determine the largest one selected from values of the regulated virtual gains as the power control value of the channel. Thereby, the power of the shared forward link data channel can be controlled in a more stable and reliable manner. Further, the threshold value is set for the virtual power according to the power control request of the mobile terminals, and the virtual power is prevented from falling below the set threshold value. Thereby, as the mobile terminals maintaining the virtual power of the threshold value request an increase in power in spite of a continuous request to decrease the power, it is possible to reduce the delay time for varying the real power of the shared forward link data channel. Furthermore, the power control of the channel is performed on the mobile terminals requesting an increase in the power using the largest virtual power value without increasing the real power value of the channel. Thereby, the power control of the shared forward link data channel is possible in a reliable manner.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings wherein:

FIG. 1 is a flowchart showing one example of a conventional method for controlling power of a forward link data channel in a one-to-one mobile communication system;

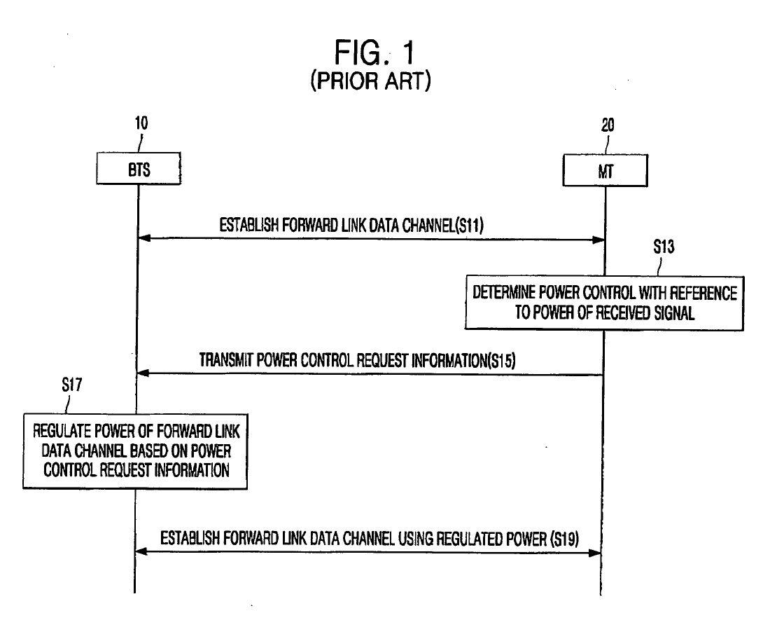

FIG. 2 is a flowchart showing one example of a conventional method for controlling power of a shared forward link data channel for multicast used in a group call service in a one-to-one mobile communication system;

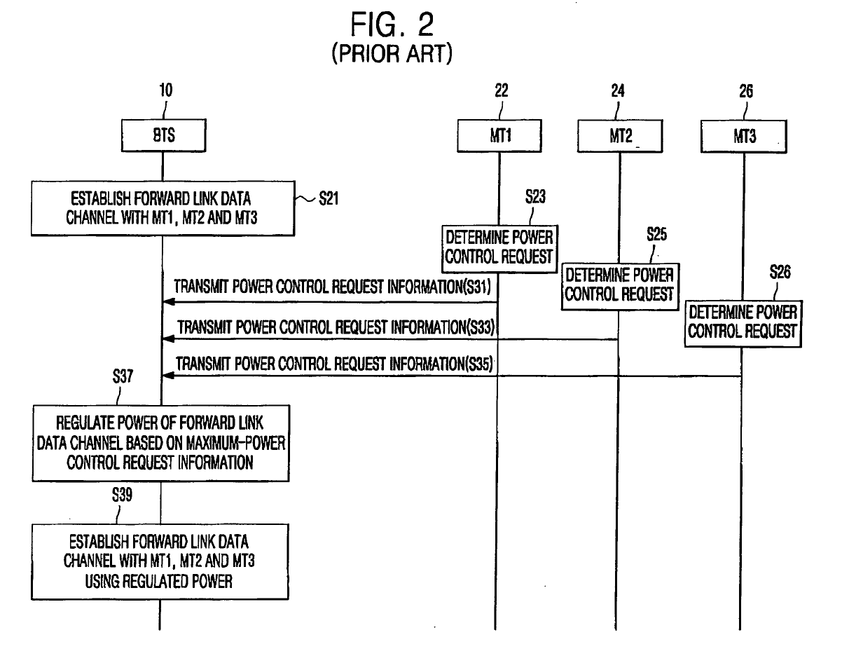

FIG. 3 is a diagram illustrating an exemplary a method for controlling power of a shared forward link data channel between a base transceiver station (BTS) and multiple mobile terminals (MTs) belonging to one group within a cell in a mobile communication system according to an embodiment of the present invention;

FIG. 4 is a flowchart illustrating an exemplary method for controlling power of a shared forward link data channel in an EV-DV system according to an embodiment of the present invention;

FIG. 5 is a graph illustrating power versus time when a BTS controls power of a shared forward link data channel by use of MT-specific virtual power according to an embodiment of the present invention;

FIG. 6 is a table illustrating virtual power and real control power in terms of power control request information requested by MTs from the BTS shown in FIG. 5.

FIG. 7 is a flowchart illustrating an exemplary method for setting a threshold value for the virtual power of the MTs to control the power of a shared forward link data channel according to an embodiment of the present invention;

FIG. 8 is a flowchart illustrating an exemplary method for setting a minimum power control value for the virtual power of the MTs to control the power of a shared forward link data channel according to an embodiment of the present invention; and

FIG. 9 is a flowchart illustrating an exemplary embodiment of a method for controlling a transmission rate of a shared forward link data channel in an EV-DO system according to an embodiment of the present invention.

Throughout the drawings, like reference numerals will be understood to refer to like parts, components and structures.

### DETAILED DESCRIPTION OF EXEMPLARY EMBODIMENTS

Hereinafter, exemplary embodiments of the present invention will be described in detail with reference to the accompanying drawings Detailed descriptions of known functions and constructions will be omitted for clarity and conciseness.

Described below are exemplary methods for controlling power of a shared forward link data channel for a Push-To-Talk (PTT) service based on multicast in a mobile communication system according to an embodiment of the present invention. Further, it is assumed that, in order to control power of one shared forward link data channel, all the mobile terminals (MTs) belonging to one group are connected to a base transceiver station (BTS) through a reverse link channel or reverse control channel, namely a reverse power sub-channel.

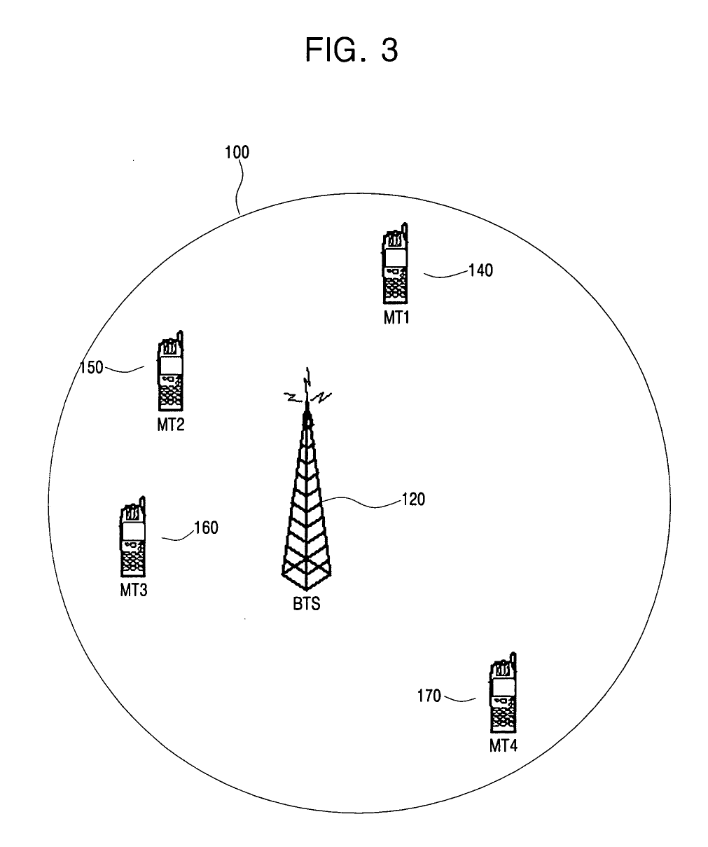

FIG. 3 is a diagram illustrating an exemplary system for explaining method for controlling power of a shared forward link data channel between a BTS and multiple MTs belonging to one group within a cell 100 in a mobile communication system according to an embodiment of the present invention.

The following description with reference to FIG. 3 describes the operation for controlling the power of the shared forward link data channel between the BTS and the MTs when implementing a group call function using multicast in the mobile communication system according to an embodiment of the present invention.

As shown in FIG. 3, a mobile communication system comprises a BTS 120 and MTs 140, 150, 160 and 170.

A shared forward link data channel is established between the BTS 120 and the MTs 140, 150, 160 and 170. The MTs 140, 150, 160 and 170 measure the power of the shared forward link data channel. Here, when the mobile communication system is a Code Division Multiple Access (CDMA) 2000 first evolution data and voice (1× EV-DV) system (hereinafter, referred to as an “EV-DV system”), the MTs 140, 150, 160 and 170 transmit power control request information needed to stably receive data to the BTS 120 through a reverse link channel. Further, when the mobile communication system is a CDMA2000 first evolution data only (1× EV-DO) system (hereinafter, referred to as an “EV-DO system”), the MTs 140, 150, 160 and 170 transmit transmission rate request information (called Data Rate Control (DRC)) needed to stably receive data to the BTS 120 through a reverse link channel.

In the EV-DV system, the power control request information may comprise a Power Control Bit (PCB), Erasure Indicator Bit (EIB), and Quality Indicator Bit (QIB), for example.

In terms of the shared forward link data channel established between the BTS 120 and the MTs 140, 150, 160 and 170, this embodiment of the present invention discloses how to control the power or transmission rate of the shared forward link data channel on the basis of the power control request information or DRC requested by the MTs 140, 150, 160 and 170.

Specifically, the EV-DV system controls the power of the shared forward link data channel on the basis of the power control request information, and the EV-DO system controls the transmission rate of the shared forward link data channel on the basis of the DRC. Thus, the following description concerns both the EV-DV and EV-DO systems.

1. Controlling Power of Shared Forward Link Data Channel in EV-DV System

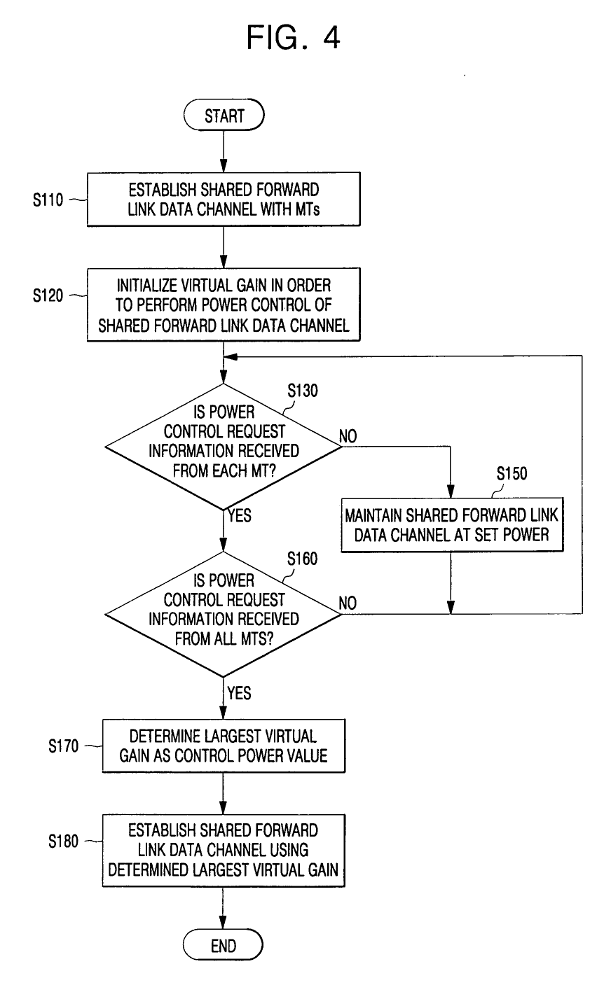

FIG. 4 is a flowchart illustrating an exemplary method for controlling power of a shared forward link data channel in an EV-DV system according to an embodiment of the present invention.

This embodiment will be described below with reference to FIGS. 3 and 4.

The BTS 120 establishes a shared forward link data channel with the MTs 140, 150, 160 and 170 located in a coverage region or area of the BTS 120 at step S110. In order to control power of the shared forward link data channel established with the MTs 140, 150, 160 and 170, the BTS 120 initializes a virtual gain (power) for each of the MTs 140, 150, 160 and 170 at step S120.

All of the MTs 140, 150, 160 and 170, which are in a group and establish the shared forward link data channel with the BTS 120, transmit PCB, EIB or QIB, which corresponds to necessary power control request information, to the BTS 120 through a reverse power sub-channel by referring to received power of the established shared forward link data channel. In other words, the MTs 140, 150, 160 and 170 transmit power control request information, requesting an increase or decrease in the power of the current shared forward link data channel, to the BTS 120.

When the BTS 120 receives the PCB as the power control request information from the MTs 140, 150, 160 and 170, the power of the shared forward link data channel is controlled in units of Power Control Groups (PCG), and thereby power control is possible in a short amount of time. Further, when receiving the EIB or QIB as the power control request information from the MTs 140, 150, 160 and 170, the BTS 120 controls the power of the shared forward link data channel based on a frame error such as outer loop power control. Thus, power control in units of frames is possible.

After initializing the virtual gain of each of the MTs 140, 150, 160 and 170, the BTS 120 determines whether the power control request information is received from the MTs 140, 150, 160 and 170 at step S130. If the power control request information is not received from the MTs 140, 150, 160 and 170, the BTS 120 maintains the shared forward link data channel at a preset power at step S150.

At step S130, if the power control request information is received from the MTs 140, 150, 160 and 170, the BTS 120 determines whether or not the power control request information is received from all of the MTs 140, 150, 160 and 170 in the coverage region 100 at step S160. If the power control request information is not received from all the MTs 140, 150, 160 and 170 within the coverage region 100, the BTS 120 repeats steps S130 and S160 until the power control request information is received from all the MTs.

In contrast, if the power control request information is received from all the MTs 140, 150, 160 and 170 within the coverage region 100, the BTS 120 regulates each virtual gain depending on the received power control request information corresponding to each of the MTs. The BTS 120 then determines the largest of the regulated virtual gains as a power control value of the shared forward link data channel at step S170. Specifically, unlike the conventional BTS which increases the power of the current channel at the request of at least one of the MTs, the BTS 120 regulates the virtual gain (power) corresponding to each of the MTs depending on the power control request information received from each of the MTs, and determines the virtual gain, which is the largest of the regulated virtual gains, as the power control value of the channel.

The BTS 120 establishes the shared forward link data channel based on the determined largest virtual gain at step S180.

Therefore, the BTS 120 initializes the virtual gain (power) for each MT in the group establishing the shared forward link data channel, and then regulates each virtual gain according to the power control request information received from the MTs and determines the greatest regulated virtual gain as the power control value of the channel. Thereby, the power of the shared forward link data channel can be controlled in a more stable and reliable manner.

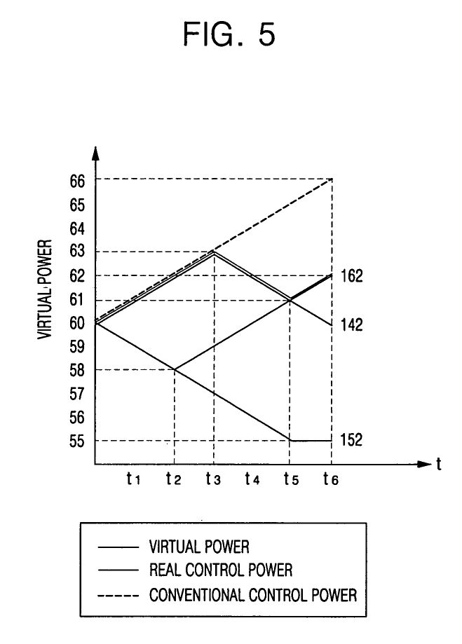

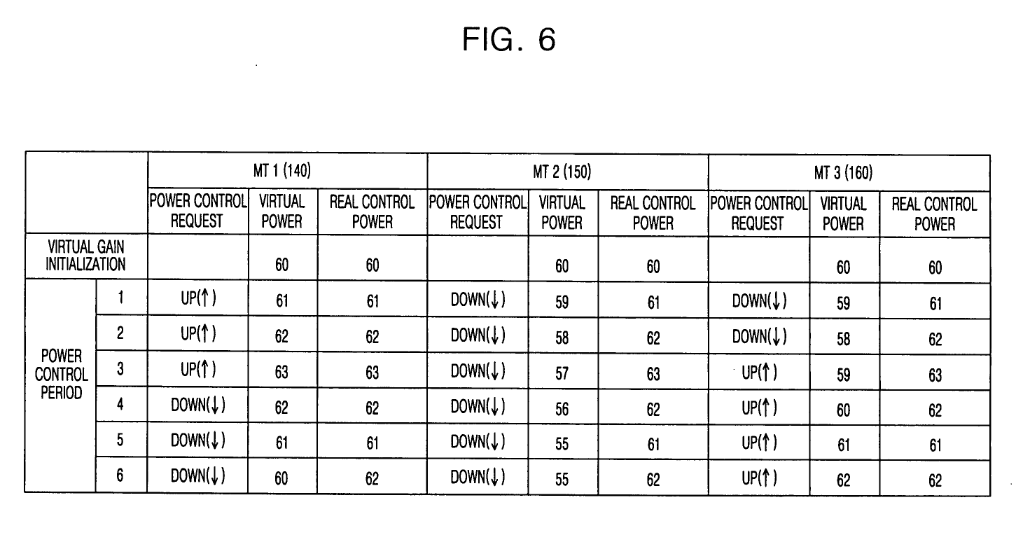

FIG. 5 is a graph illustrating power versus time when a BTS 120 controls power of a shared forward link data channel by use of MT-specific virtual power. FIG. 6 is a table illustrating virtual power and real control power in terms of power control request information which MTs request from the BTS 120 in FIG. 5.

In FIG. 5, reference numeral 142 shows a variation of virtual power over time, in which the virtual power is adjusted by the BTS 120 on the basis of power control request information received from a MT1 140, reference numeral 152 shows a variation of virtual power over time, in which the virtual power is adjusted by the BTS 120 on the basis of power control request information received from a MT2 150, and reference numeral 162 shows a variation of virtual power over time, in which the virtual power is adjusted by the BTS 120 on the basis of power control request information received from a MT3 160.

Further, in FIG. 5, a thin solid line represents the virtual power of each of the MTs 140, 150 and 160 adjusted by the BTS 120 in accordance with an embodiment of the present invention. A thick solid line represents real control power of the shared forward link data channel established to the MTs 140, 150 and 160 on the basis of the virtual power of each of the MTs 140, 150 and 160 adjusted by the BTS 120 in accordance with an embodiment of the present invention. And, a thick dotted line represents conventional control power of the shared forward link data channel.

The BTS 120 initializes a virtual gain (power) of each of the MTs 140, 150 and 160 with which the shared forward link data channel is established. In the present embodiment, the BTS 120 initializes initial virtual gains of the MTs 140, 150 and 160 at a virtual power value or level 60.

When receiving power control request information from the MTs 140, 150 and 160 in a first power control period t1, the BTS 120 adjusts each virtual power based on the power control request information of the MTs 140, 150 and 160. According to an embodiment of the present invention, at the first power control period t1, the BTS 120 adjusts the virtual power of the MT1 140 requesting an increase in the power value to 61, and the virtual power of the MT2 150 and MT3 160 requesting a decrease in the power value to 59. The BTS 120 compares magnitudes of the adjusted virtual power of the MTs 140, 150 and 160, and then determines the largest virtual power as a power control value of the shared forward link data channel. Accordingly, the BTS 120 sets the power of the shared forward link data channel to a value of 61 and then establishes the channel.

In a third power control period t3, the BTS 120 adjusts the virtual power of the MT1 140 requesting an increase in the power value to 63, the virtual power of the MT2 150 requesting a decrease in the power value to 57, and the virtual power of the MT3 160 requesting an increase in the power value to 59. The BTS 120 then determines the largest of the adjusted virtual power values of the MTs 140, 150 and 160 as the power control value of the shared forward link data channel. Accordingly, the BTS 120 sets the power of the shared forward link data channel to 63 and then establishes the channel.

In a fourth power control period t4, the BTS 120 adjusts the virtual power of the MT1 140 requesting a decrease in the power value to 62, the virtual power of the MT2 150 requesting a decrease in the power value to 56, and the virtual power of the MT3 160 requesting an increase in the power value to 60. The BTS 120 then determines the largest virtual power value, 62, of the MT1 140 as the power control value of the shared forward link data channel, and then establishes the channel.

In a fifth power control period t5, the BTS 120 adjusts the virtual power of the MT1 140 requesting a decrease in the power value to 61, the virtual power of the MT2 150 requesting a decrease in the power value to 55, and the virtual power of the MT3 160 requesting an increase in the power value to 61. The BTS 120 then determines the largest virtual power values, 61, of the MT1 140 and MT3 160 as the power control value of the shared forward link data channel, and then establishes the channel.

In a sixth power control period t6, the BTS 120 adjusts the virtual power of the MT1 140 requesting a decrease in the power value to 60, the virtual power of the MT2 150 requesting a decrease in the power value to 55, and the virtual power of the MT3 160 requesting an increase in the power value to 62. The BTS 120 then maintains the previous virtual power value, 55, for the MT2 150 requesting a decrease in the power because when the reception is deteriorated, the MT2 150 requests an increase in the power, and thereby the virtual power of the MT2 150 becomes the largest of the three virtual power values, so that considerable time is needed to achieve a variation of the real power of the shared forward link data channel.

For example, it is assumed that the MT2 150 whose real control power is adjusted to 63 in the sixth power control period t6 requests an increase in the power in a seventh power control period t7. If no threshold value is set, the virtual power of the MT2 150 will be adjusted from 54 to 55. Thus, in response to the MT2 150 requesting an increase in virtual power if the real power value is 62, the BTS 120 has to increase the virtual power of the MT2 150 at least eight times under the condition that the real power value is not varied. However, when the threshold value is set to 55, the virtual power of the MT2 150 will be adjusted from 54 to 56. Thus, in response to the MT2 150 requesting an increase in the virtual power when the channel has a real power value of 62, the BTS 120 is able to increase the virtual power of the MT2 150 only at least seven times under the condition that the real power value is not varied.

For this reason, in the present embodiment, the virtual power of each MT is prevented from falling below the predetermined value.

In the sixth power control period t6, the BTS 120 determines the virtual power value, 62, of the MT3 160 that is the largest of the adjusted virtual power values of the MTs 140, 150 and 160 as the power control value of the shared forward link data channel, and then establishes the channel.

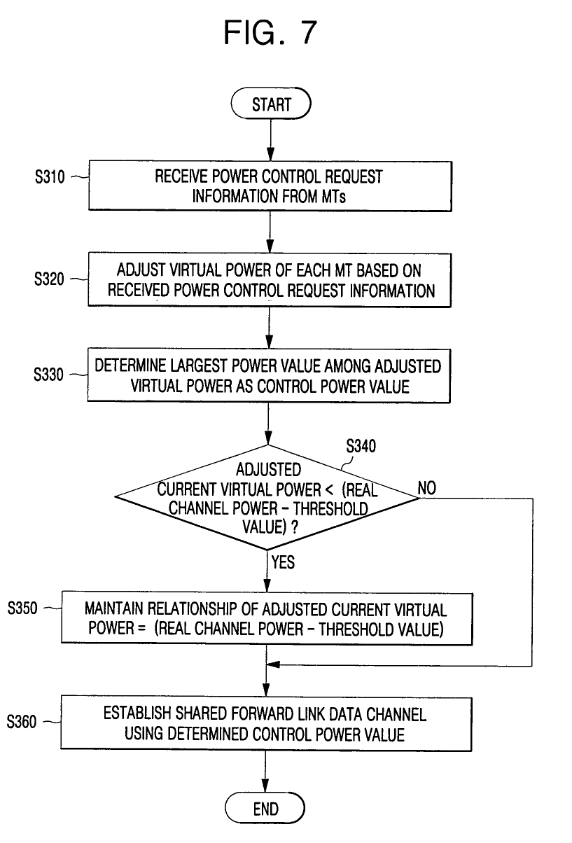

FIG. 7 is a flowchart showing an exemplary embodiment of a method for setting a threshold value for virtual power of MTs to thus control power of a shared forward link data channel according to an embodiment of the present invention.

First, while a shared forward link data channel is established with the MTs 140, 150, 160 and 170, the BTS 120 receives power control request information from the MTs 140, 150, 160 and 170 at step S3 10. Then, the BTS 120 adjusts the virtual power of each of the MTs 140, 150, 160 and 170 on the basis of the received power control request information at step S320.

The BTS 120 determines the largest of the adjusted virtual power values as a control power value of the shared forward link data channel at step S330.

Meanwhile, the BTS 120 compares whether or not the current virtual power of each of the MTs 140, 150, 160 and 170 adjusted at step S320 is less than a value obtained by subtracting a set threshold value from the real control power of the shared forward link data channel at step S340.

If at least one of the adjusted current virtual power is less than the value obtained by subtracting the set threshold value from the real control power of the shared forward link data channel, the BTS 120 maintains the shared forward link data channel at the value obtained by subtracting the set threshold value from the real control power of the shared forward link data channel without decreasing the adjusted virtual power at step S350.

The BTS 120 then establishes the shared forward link data channel at step S360 using the control power value determined at step S330.

In this manner, the threshold value is set for the virtual power according to the power control request of the MTs, and the adjusted virtual power is prevented from falling below the value obtained by subtracting the set threshold value from the real control power of the shared forward link data channel. Thereby, in spite of continuous requests to decrease the power, the adjusted virtual power is maintained above a predetermined value. Thus, when the MTs request an increase in the power, it is possible to reduce a delay time for varying the real power of the shared forward link data channel. Further, the power control of the channel is performed on the MTs requesting to increase the power using the largest virtual power value without increasing the real power value of the channel, and thereby the power control of the shared forward link data channel is possible in a reliable manner.

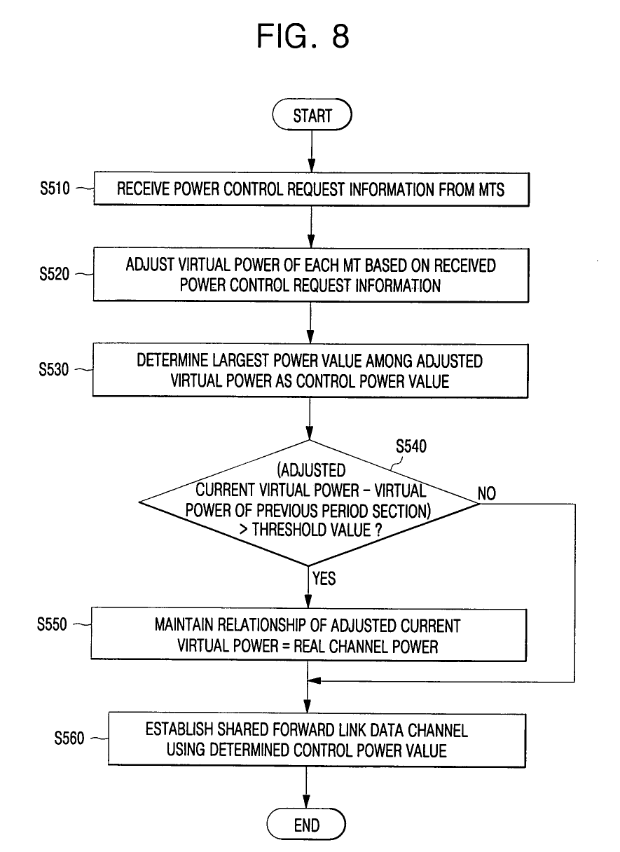

FIG. 8 is a flowchart showing an exemplary method for controlling power of a shared forward link data channel where no limitation is placed to maintain virtual power of MTs above a constant value according to an embodiment of the present invention.

Unlike the method of setting the threshold value to reduce the time which is taken to maintain the virtual power to be the power value required by the MTs as shown in FIG. 7, FIG. 8 provides a method where, when the virtual power increases above a predetermined value for a predetermined time, the MTs directly adopt the virtual power as the real power of the channel without gradually increasing the virtual power.

First, while a shared forward link data channel is established with the MTs 140, 150, 160 and 170, the BTS 120 receives power control request information from the MTs 140, 150, 160 and 170 at step S510. Then, the BTS 120 adjusts virtual power of each of the MTs 140, 150, 160 and 170 on the basis on the received power control request information at step S520.

The BTS 120 determines the largest of the adjusted virtual power values as a control power value of the shared forward link data channel at step S530.

At step 540, the BTS 120 compares whether a set threshold value is greater than a value obtained by subtracting the previous virtual power at an arbitrary power control period section from the current virtual power of each of the MTs 140, 150, 160 and 170 adjusted at step S520.

If the set threshold value is not greater than the value obtained by subtracting the previous virtual power at an arbitrary power control period section from the adjusted current virtual power, the BTS 120 establishes the shared forward link data channel using the power control value determined at step S530. However, if the set threshold value is greater than the value obtained by subtracting the previous virtual power at an arbitrary power control period section from the adjusted current virtual power, the BTS 120 maintains the virtual power adjusted at step S520 as the real power of the shared forward link data channel at step S550. At step S560, the BTS 120 establishes the shared forward link data channel using the power control value determined at step S530.

2. Controlling Transmission Rate of Shared Forward Link Data Channel in EV-DO System

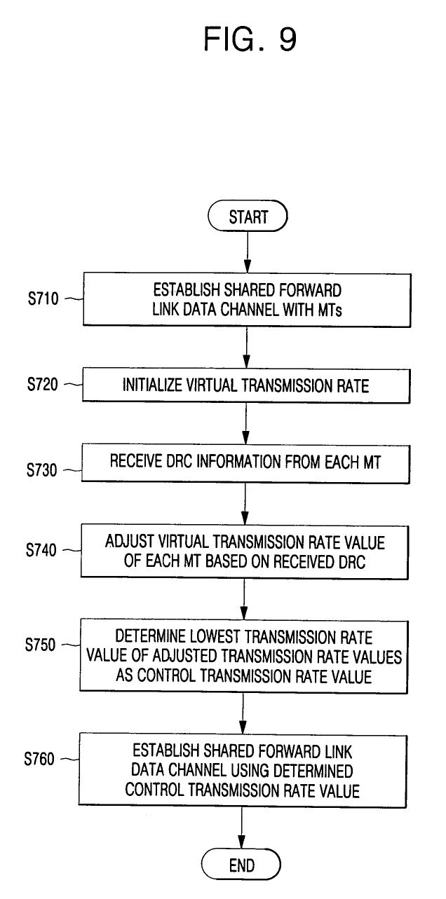

FIG. 9 is a flowchart illustrating an exemplary method for controlling a transmission rate of a shared forward link data channel in an EV-DO system according to an embodiment of the present invention.

First, the BTS 120 establishes a shared forward link data channel with the MTs 140, 150, 160 and 170 that exist in a group at step S710. At step S720, the BTS 120 initializes a virtual transmission rate of each of the MTs 140, 150, 160 and 170 using a power value of the established shared forward link data channel.

Each of the MTs 140, 150, 160 and 170 checks the power of the established shared forward link data channel to determine transmission rate request information (or data rate control (DRC)) needed to stably receive data. The MTs 140, 150, 160 and 170 each transmit the determined DRC to the BTS 120.

The BTS 120 receives the DRC from each of the MTs 140, 150, 160 and 170 at step S730. The BTS 120 adjusts a value of the virtual transmission rate of each of the MTs 140, 150, 160 and 170 on the basis of the received DRC at step S740.

The BTS 120 determines the lowest of the adjusted virtual transmission rate values as a control transmission rate value of the shared forward link data channel at step S750. Thereby, the BTS 120 establishes the shared forward link data channel using the determined control transmission rate value at step S760.

In this case, among the MTs 140, 150, 160 and 170, excluding the MT that needs the lowest transmission rate, the other MTs request the BTS 120 to increase the transmission rate. However, the real transmission rate of the shared forward link data channel is varied on the basis of the MT that needs the lowest transmission rate. Thus, as long as the transmission rate required at the MT that needs the lowest transmission rate is not varied, the real transmission rate of the shared forward link data channel is not varied.

When the transmission rate of the shared forward link data channel is controlled for the MTs in accordance with an embodiment of the present invention, the transmission rate required of the MTs differs from that of the data transmitted at the BTS 120. Therefore, the MTs receive the data transmitted from the BTS 120 through blind detection.

Another example will be described as follows, which is directed to a method for controlling the transmission rate of the shared forward link data channel according to an embodiment of the present invention.

Specifically, the BTS allocates the data transmission rate information of the shared forward link data channel to a portion of the MAC and transmits the information in a forward data rate indicator format or through a downward control channel to the MTs. Thereby, the MTs receive the data transmission rate information to detect the data transmission rate, and then enter a reception standby accordingly so as to make reception possible.

According to this embodiment of the present invention, the BTS initializes the virtual gain (power) for each of the MTs that are in the group establishing the shared forward link data channel, and then regulates each virtual gain on the basis of the power control request information received from the MTs to determine the largest of the regulated virtual gain values as the power control value of the channel. Thereby, the power of the shared forward link data channel can be controlled in a stable and reliable manner.

Further, the threshold value is set for the virtual power according to the power control request of the MTs, and the virtual power is prevented from falling below the set threshold value. Thereby, as the MTs maintaining the virtual power of the threshold value request an increase in power in spite of continuous requests to decrease the power, it is possible to reduce the delay time for varying the real power of the shared forward link data channel.

Furthermore, the power control of the channel is performed on the MTs requesting an increase the power using the largest of the virtual power values without increasing the real power value of the channel. Thereby, reliable power control of the shared forward link data channel is possible.

Although exemplary embodiments of the present invention have been described, it will be understood by those skilled in the art that the present invention should not be limited to the described exemplary embodiments. Rather, various changes and modifications can be made within the spirit and scope of the present invention, as defined by the following claims.

What is claimed is:

1. A method for controlling power of a shared forward link data channel for performing multicasting in a mobile communication system, the method comprising the steps of:
initializing a virtual gain for each mobile terminal with which the shared forward link data channel is established;
receiving power control request information from each mobile terminal to adjust the virtual gain of each mobile terminal;
determining a power control value of the shared forward link channel by using the adjusted virtual gains; and
transmitting the shared forward link channel with the determined power control value.

2. The method of claim 1, wherein determining a power control value of the shared forward link channel is selecting a largest virtual gain among the adjusted virtual gains as the power control value of the shared forward link channel.

3. The method of claim 1, wherein the power control request information comprises at least one of a Power Control Bit (PCB), Erasure Indicator Bit (EIB), and Quality Indicator Bit (QIB).

4. The method of claim 1, further comprising the steps of:
comparing the adjusted virtual gain of each mobile terminal with a value obtained by subtracting a predetermined threshold value from the determined power control value of the shared forward link channel; and
when at least one of the adjusted virtual gains is less than the value obtained by subtracting the predetermined threshold value from the determined power control value of the shared forward link channel, maintaining the at least one adjusted virtual gain at the value obtained by subtracting the predetermined threshold value from the determined power control value of the shared forward link data channel.

5. The method of claim 1, further comprising the steps of:
comparing a predetermined threshold value with a value obtained by subtracting a virtual gain of a previous arbitrary period section from the adjusted virtual gain of each mobile terminal; and
when the value obtained by subtracting the virtual gain of the previous arbitrary period section from the adjusted virtual gain is greater than the predetermined threshold value, changing the adjusted virtual gain into the currently determined power control value [set power] of the shared forward link channel.

6. A method for controlling a transmission rate of a shared forward link data channel for performing multicasting in a mobile communication system, the method comprising the steps of:
initializing a virtual transmission rate for each mobile terminal with which the shared forward link data channel is established;
receiving transmission rate request information from each mobile terminal to adjust the virtual gain of each mobile terminal;
selecting a lowest transmission rate among the adjusted virtual transmission rates as a control transmission rate value of the shared forward link data channel; and
regulating the transmission rate of the shared forward link data channel to the selected control power value.

7. The method of claim 6, wherein the transmission rate request information comprises Data Rate Control (DRC).

8. A method for controlling a transmission rate of a shared forward link data channel for performing multicasting in a mobile communication system, the method comprising the steps of:
transmitting, at a base transceiver station, data transmission rate information of the shared forward link data channel to mobile terminals with which the shared forward link data channel is established;
receiving, at each of the mobile terminals, the data transmission rate information to detect a data transmission rate allocated to each of the mobile terminals; and
maintaining, at each of the mobile terminals, a state in which reception is possible based on the detected data transmission rate.

9. The method of claim 8, wherein the data transmission rate information is transmitted to each of the mobile terminals in a forward data rate indicator format.

10. The method of claim 9, wherein the data transmission rate information is allocated to a predetermined portion of Media Access Control (MAC) and transmitted.

11. The method of claim 9, wherein the data transmission rate information is transmitted to each of the mobile terminals through a downward control channel.

12. A system for controlling a transmission rate of a shared forward link data channel for performing multicasting in a mobile communication system, comprising:
a base transceiver station for transmitting data transmission rate information of the shared forward link data channel to mobile terminals with which the shared forward link data channel is established; and
the mobile terminals for receiving the data transmission rate information for detecting a data transmission rate allocated to each of the mobile terminals and maintaining a state in which reception is possible based on the detected data transmission rate.

13. The system of claim 12, wherein the data transmission rate information is transmitted to each of the mobile terminals in a forward data rate indicator format.

14. The system of claim 13, wherein the data transmission rate information is allocated to a predetermined portion of Media Access Control (MAC) and transmitted.

15. The system of claim 13, wherein the data transmission rate information is transmitted to each of the mobile terminals through a downward control channel.

16. The system of claim 12, wherein the transmission rate request information comprises Data Rate Control (DRC).

17. A set of instructions on a computer readable medium for controlling power of a shared forward link data channel for performing multicasting in a mobile communication system, the comprising:
a first set of instructions for initializing a virtual gain for each mobile terminal with which the shared forward link data channel is established;
a second set of instructions for receiving power control request information from each mobile terminal to adjust the virtual gain of each mobile terminal;
a third set of instructions for selecting a largest virtual gain among the adjusted virtual gains as a control power value of the shared forward link data channel; and
a fourth set of instructions for regulating the power of the shared forward link data channel to the selected control power value.

18. The set of instructions on a computer readable medium of claim 17, further comprising:
a fifth set of instructions for comparing the adjusted virtual gain of each mobile terminal with a value obtained by subtracting a set threshold value from real control power of the shared forward link data channel; and
a sixth set of instructions for maintaining the at least one adjusted virtual gain at the value obtained by subtracting the set threshold value from the real control power of the shared forward link data channel when at least one of the adjusted virtual gains is less than the value obtained by subtracting the set threshold value from the real control power of the shared forward link data channel.
